(19) United States
(12) Patent Application Publication
(10) Pub. No.: US 2019/0314909 A1
(43) Pub. Date: Oct. 17, 2019

(54) METHOD FOR MANUFACTURING A TOOTHING AND TOOTHING

(71) Applicant: Rolls-Royce Deutschland Ltd & Co KG, Blankenfelde-Mahlow (DE)

(72) Inventors: David KRUEGER, Potsdam (DE); Peter Michael FLASSIG, Berlin (DE); Bernd MEISSNER, Nuthetal (DE); Chen-Xiang CHAO, Berlin (DE)

(21) Appl. No.: 16/376,647

(22) Filed: Apr. 5, 2019

(30) Foreign Application Priority Data
Apr. 12, 2018 (DE) 10 2018 108 753.5

(51) Int. Cl. B23F 17/00; F16H 55/08

(52) U.S. Cl. CPC B23F 17/005; F16H 55/0813

(57) ABSTRACT

A method for producing a toothing with multiple teeth of a gear element for a gas turbine engine including the following steps: predefining a tooth root shape that defines a shape of the toothing in the area of tooth roots of adjacent teeth, wherein the tooth root shape is described by a spline curve at least in certain sections, in particular completely; and forming the toothing with the tooth root shape. A toothing for a gear element includes multiple teeth and a tooth root shape which is formed in the area of tooth roots of adjacent teeth and which is formed according to a spline curve at least in certain sections, in particular completely.

This application claims priority to German Application No. 10 2018 108 753.5 filed Apr. 12, 2018, which application is incorporated by reference herein.

The present disclosure relates to a method for producing a toothing according to claim 1, to a toothing according to claim 16, to a gear element and a gas turbine engine.

Toothings have multiple teeth with respectively one tooth tip and a tooth root located opposite the tooth tip, with the teeth being connected to each other via the tooth roots. A possible tooth root shape is a trochoid, which can be created in a rolling process of a tool, e.g. during gear hobbing. The shape of the toothing in the area of the tooth roots of adjacent teeth regularly has a great impact on the load-carrying capacity of the toothing.

It is the objective of the present invention to improve the manufacturing of a toothing.

According to one aspect, a method for producing a toothing with multiple teeth, in particular a gear element for a gas turbine engine, is provided. The method comprises the step of predefining a tooth root shape which defines a shape of the toothing in the area of tooth roots of adjacent teeth, wherein the tooth root shape is described by a spline curve at least in certain sections, in particular completely. The method further comprises the step of forming the toothing with the tooth root shape. The toothing may for example be formed at a work piece, so that a gear element is produced from a work piece.

The tooth root shape extends e.g. across a portion of a side of a tooth and across a portion of a side of the adjacent tooth of the toothing. The tooth root shape can border an involute profile of each of the two teeth. In the transverse section (perpendicular to a rotational axis of the toothing), the involute profile is e.g. described by an involute. The involute profile of each tooth flank of the toothing e.g. extends from the adjacent tooth root shape to the tooth tip of the respective tooth. The toothing can be formed at a spur gear, e.g. inside a root form diameter (also referred to as the “true form diameter”, TF) of the toothing of the spur gears. The rootform diameter is that diameter of the toothing at which the transition from the tooth root curve to the involute profile takes place.

The description of the tooth root shape by means of a spline curve can be adjusted to the given application case in a particularly flexible manner, whereby the method for producing the toothing can be improved. Also, in this way toothings with a particularly high load-carrying capacity can be provided. The description of the tooth root shape by means of the spline curve can e.g. occur in the transverse section of the toothing.

A spline function of a certain degree is a function that is comprised piecewise of polynomials of no higher than that degree. The spline curve may e.g. have a degree of more that or equal to 2, in particular a degree of more that or equal to 3. The spline curve is e.g. continuously differentiable, in particular one time less than the grade. The spline curve can e.g. have a C0, C1 or C2 continuity at a defined degree 3.

It can be provided that the tooth root shape (104A-104C) is not described by a Bézier curve and/or that it is not describable by a Bézier curve. For example, the spline curve cannot be described by a Bézier curve.

The spline curve may optionally be a B-spline curve. A B-spline curve is a spline curve that is shown with respect to a base of B-spline functions. A B-spline function is a spline function with a compact support. B-spline functions can be calculated by using Cox-de Boor recursion formula. The B-spline curve is determined by control points (also referred to as de Boor points). The B-spline curve is always located in the convex hull of the control points. The B-spline curve with a degree g can be defined as follows (e.g. in the transverse section of the toothing):

$$[ \begin{matrix}x ( t ) \\ y ( t )\end{matrix} ] = {\sum }_{k = 0}^{n} {N}_{k , g} ( t ) [ \begin{matrix}{x}_{k} \\ {y}_{k}\end{matrix} ]$$

Here,

$$[ \begin{matrix}x ( t ) \\ y ( t )\end{matrix} ]$$

represent possible points of the B-spline curve as a function of the B-spline curve parameter t which can be varied in the range of 0<=t<=1 (zero smaller or equal to t smaller or equal to 1). Further,

$$[ \begin{matrix}{x}_{k} \\ {y}_{k}\end{matrix} ]$$

represent the n+1 control points of the B-spline curve. The N_{k,g}(t) form the known normed B-spline functions and the base of the B-spline curve. The (B) spline curve can be an interpolating (B) spline curve. For example, the (B) spline curve interpolates its defining points. The interpolation conditions can be defined as follows:

$$[ \begin{matrix}x ( {t}_{i} ) \\ y ( {t}_{i} )\end{matrix} ] = {\sum }_{k = 0}^{n} {N}_{k , g} ( {t}_{i} ) [ \begin{matrix}{x}_{k} \\ {y}_{k}\end{matrix} ] {=}^{!} [ \begin{matrix}{x}_{i} \\ {y}_{i}\end{matrix} ]$$

Here,

$$[ \begin{matrix}{x}_{i} \\ {y}_{i}\end{matrix} ]$$

represent the (n+1) defining points through which the B-spline curve must run.

The spline curve comprises multiple polynomials that are composed piecewise (at least at one node, in particular at two, three, or more than three nodes).

The toothing may e.g. be a spur gear toothing. The description of the tooth root shape by means of the spline curve is in particular realized in the transverse section of the toothing.

The (B)-spline curve can have a parameter set with multiple parameters, wherein the parameters of the parameter set of the spline curve are respectively defined in polar coordinates as follows: a center point of a connecting line between two facing flanks of adjacent teeth at the height of a root form diameter of the toothing is defined; the semicircle of a circle about the center point that is facing towards the tooth root shape is divided into multiple, in particular equidistant, angles; and the respective parameter is defined by respectively one of the angles and a radial distance to the center point. Thus, the parameters can be indicated in polar coordinates beginning at the center point. This facilitates a simple calculation of the spline curve. The parameter set can be comprised of the defining points of the B-spline curve. Such a parameter set can be particularly easily scalable and can be applied to any size of the toothings.

The step of predefining the tooth root shape can comprise optimizing the parameters. In this manner, a parameter set can be found that facilitates a toothing with a particularly high load-carrying capacity.

The step of optimizing the parameters can comprise defining a perturbation curve (or control cam) described by a parameter set. Here, the parameters of the parameter set of the (B) spline curve can be determined through the perturbation curve. In this manner, the optimizing can be simplified, since (i) the design space dimension can be reduced, (ii) complex tooth root geometries can maintain their qualitative shape and (iii) implicit geometric requirements are met a priori. In addition, it has been shown that particularly good results can be obtained in particular in this manner.

Optionally, the perturbation curve is a spline curve, in particular a B-spline curve. Alternatively, the perturbation curve can be a polynomial function, a Bézier curve (e.g. of the third degree) or a NURBS curve (non-uniform rationale B-spline curve).

In one embodiment, the number of parameters of the perturbation curve is smaller than the number of parameters of the (B) spline curve. This facilitates a further simplification of the optimizing process.

Optimizing the parameter values can comprise the following: multiple parameter sets with parameter values that vary from one parameter set to the other parameter set are predetermined. For each of the multiple parameter sets, a tooth root load-carrying capacity of a toothing having a tooth root shape is determined, which is described by a spline curve with the respective parameter set. Then, the parameter set of that spline curve is selected for which the highest tooth root load-carrying capacity has been determined. Optimizing can comprise establishing a random number (or a pseudo random number). The (pseudo) random number is e.g. used when varying the parameter sets. The varied parameter sets may e.g. be parameters of the perturbation curve, which may e.g. be control points. Alternatively, the varied parameter sets can be parameters of the spline curve (of the tooth root shape) itself, which may e.g. be the defining points or the control points.

The spline curve (in particular the B-spline curve) may for example have 4, 5 or more than 5, in particular 10 or more than 10, control points. In one embodiment, the (B) spline curve has 25 control points or more. In this manner, a great variety of tooth root shapes can be rendered. The B-spline function comprises e.g. at least 4 defining points and correspondingly the same number of control points. In this manner, a polynomial order of 3 (and thus C2-continuity) can be ensured. Optionally, the degree of the (B) spline curve can be set to exactly 3 and at the same time more than 4 control points can be used, which allows for a high flexibility when producing the optimized tooth root shape.

Optionally, the (B) spline curve has an uneven number of control points. Here, particularly good tooth root strengths can be achieved in some application cases. Alternatively or additionally, the perturbation curve has an uneven number of control points.

As has already been mentioned, the (B) spline curve can be an interpolating (B) spline curve. For example, the (B) spline curve interpolates its defining points.

Optionally, the spline curve of the tooth root shape is a non-interpolated spline curve. Here, it is e.g. possible that the spline curve is determined by the control points KP.

The step of forming the toothing can comprise providing a work piece and machining, in particular cutting machining. The machining can comprise a non-rolling machining procedure, in particular profile milling or profile grinding. Alternatively, e.g. a gear hobbing of the work piece is possible. Thus, a gear element with the toothing can be produced. Alternatively, a gear element with the toothing can be primary formed. Thus, one aspect refers to a corresponding method for producing a gear element. The gear element can be a gear wheel, in particular for a gearbox of a gas turbine engine.

According to one aspect, a method for producing a gas turbine engine is indicated in which a gearbox with a gear element is provided that is produced as previously described.

What is provided according to one aspect is a toothing for a gear element, in particular of a gear element. The toothing can be produced according to a method according to any embodiment described herein. The toothing comprises multiple teeth and a tooth root shape formed in the area of tooth roots of adjacent teeth. Here, the tooth root shape is formed at least in certain sections, in particular completely, according to a spline curve.

The toothing can be symmetrical or asymmetrical. In both cases, the tooth root shape can be symmetrical or asymmetrical. Further, the toothing can be formed in a straight or oblique manner.

What is provided according to one aspect is a gear element, in particular for a gas turbine engine. The gear element may have any desired toothing described herein. The gear element may for example be an element of a planetary gearbox, e.g. a planetary gear, alternatively a sun gear or a ring gear of the planetary gearbox. Optionally, the planetary gearbox is embodied for driving the fan of the gas turbine engine.

What is provided according to one aspect is a gas turbine engine, in particular for an aircraft. The gas turbine engine comprises a core engine that comprises a turbine, a compressor and a core shaft that connects the turbine with the compressor; a fan that is positioned upstream of the core engine, wherein the fan comprises multiple fan blades; and a gearbox that can be driven by the core shaft, wherein the fan can be driven by means of the gearbox with a lower rotational speed than the core shaft, wherein the gearbox comprises a gear element with a toothing according to any of the embodiments described herein.

In the gas turbine engine, the turbine can be a first turbine, the compressor can be a first compressor and the core shaft can be a first core shaft. The core engine can further comprise a second turbine, a second compressor and a second core shaft that connects the second turbine to the second compressor. The second turbine, the second compressor and the second core shaft can be arranged in such a manner that they can rotate with a higher rotational speed than the first core shaft.

As noted elsewhere herein, the present disclosure may relate to a gas turbine engine, such as for example an aircraft engine. Such a gas turbine engine may comprise a core engine comprising a turbine, a combustion device, a compressor, and a core shaft connecting the turbine to the compressor. Such a gas turbine engine may comprise a fan (having fan blades) located upstream of the core engine.

Arrangements of the present disclosure may be particularly, although not exclusively, beneficial for gear fans that are driven via a gearbox. Accordingly, the gas turbine engine may comprise a gearbox that is driven via the core shaft, with its drive driving the fan in such a manner that it has a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and the compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gearbox may be embodied to be driven by the core shaft that is configured to rotate (for example in use) at the lowest rotational speed (for example the first core shaft in the example above). For example, the gearbox may be embodied to be driven only by the core shaft that is configured to rotate (for example in use) at the lowest rotational speed (for example only by the first core shaft, and not the second core shaft, in the example above). Alternatively, the gearbox may be embodied to be driven by one or multiple shafts, for example the first and/or second shaft in the above example.

In a gas turbine engine as described and/or claimed herein, a combustion device may be provided axially downstream of the fan and the compressor (or the compressors). For example, the combustion device may be located directly downstream of the second compressor (for example at the exit thereof), if a second compressor is provided. By way of further example, the flow at the exit to the combustor may be provided to the inlet of the second turbine, if a second turbine is provided. The combustion device may be provided upstream of the turbine(s).

The or each compressor (for example the first compressor and the second compressor according to the above description) may comprise any number of stages, for example multiple stages. Each stage may comprise a row of rotor blades and a row of stator vanes, which may be variable stator vanes (i.e. in that their angle of incidence may be variable). The row of rotor blades and the row of stator vanes may be axially offset with respect to each other.

The or each turbine (for example the first turbine and second turbine according to the above description) may comprise any number of stages, for example multiple stages.

Each stage may comprise a row of rotor blades and a row of stator vanes. The row of rotor blades and the row of stator vanes may be axially offset with respect to each other.

Each fan blade may have a radial span width extending from a root (or hub) at a radially inner gas-washed location, or from a 0% span position to a tip with a 100% span width. Here, the ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in a closed range bounded by any two values in the previous sentence (i.e., the values may represent upper or lower bounds). These ratios may commonly be referred to as the hub-to-tip ratio. The radius at the hub and the radius at the tip may both be measured at the leading edge (or the axially forwardmost) edge of the blade. The hub-to-tip ratio refers, of course, to the gas-washed portion of the fan blade, i.e. the portion that is located radially outside any platform.

The radius of the fan may be measured between the engine centerline and the tip of a fan blade at its leading edge. The fan diameter (which may generally be twice the radius of the fan) may be greater than (or on the order of) any of: 250 cm (about 100 inches), 260 cm, 270 cm (about 105 inches), 280 cm (about 110 inches), 290 cm (about 115 inches), 300 cm (about 120 inches), 310 cm, 320 cm (about 125 inches), 330 cm (about 130 inches), 340 cm (about 135 inches), 350cm, 360cm (about 140 inches), 370 cm (about 145 inches), 380 (about 150 inches) cm or 390 cm (about 155 inches). The fan diameter may be in a closed range bounded by any two of the values in the previous sentence (i.e. the values may represent upper or lower bounds).

The rotational speed of the fan may vary during operation. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range from 1700 rpm to 2500 rpm, for example in the range of between 1800 rpm to 2300 rpm, for example in the range of between 1900 rpm to 2100 rpm. Purely by way of further non-limitative example, the rotational speed of the fan at cruise conditions for an engine having a fan diameter in the range of between 320 cm to 380 cm may be in the range of between 1200 rpm to 2000 rpm, for example in the range of between 1300 rpm to 1800 rpm, for example in the range of between 1400 rpm to 1600 rpm.

In use of the gas turbine engine, the fan (with the associated fan blades) rotates about a rotational axis. This rotation results in the tip of the fan blade moving with a velocity Uₜᵢₚ. The work done by the fan blades on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as the fan tip radius at the leading edge multiplied by the angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (with all units in this paragraph being) Jkg⁻¹K⁻¹/(ms⁻¹)²). The fan tip loading may be in a closed range bounded by any two of the values in the previous sentence (i.e. the values may represent upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements, the bypass ratio may be greater than (or on the order of): 10, 10.5, 11, 11.5, 12, 12.5, 13, 13.5, 14, 14.5, 15, 15.5, 16, 16.5, or 17. The bypass ratio may be in a closed range bounded by any two of the values in the previous sentence (i.e. the values may represent upper or lower bounds). The bypass duct may be substantially annular. The bypass duct may be radially outside the core engine. The radially outer surface of the bypass duct may be defined by a nacelle and/or a fan housing.

The overall pressure ratio of a gas turbine engine as described and/or claimed herein may be defined as the ratio of the stagnation pressure upstream of the fan to the stagnation pressure at the exit of the highest pressure compressor (before entry into the combustion device). By way of non-limitative example, the overall pressure ratio of a gas turbine engine as described and/or claimed herein at cruising speed may be greater than (or on the order of): 35, 40, 45, 50, 55, 60, 65, 70, 75. The overall pressure ratio may be in a closed range bounded by any two of the values in the previous sentence (i.e. the values may represent upper or lower bounds).

Specific thrust of an engine may be defined as the net thrust of the engine divided by the total mass flow through the engine. At cruise conditions, the specific thrust of an engine as described and/or claimed herein may be less than (or on the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in a closed range bounded by any two of the values in the previous sentence (i.e. the values may represent upper or lower bounds). Such engines may be particularly efficient as compared to conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of): 160 kN, 170 kN, 180 kN, 190 kN, 200 kN, 250 kN, 300 kN, 350 kN, 400 kN, 450 kN, 500 kN, or 550 kN. The maximum thrust may be in a closed range bounded by any two of the values in the previous sentence (i.e. the values may represent upper or lower bounds). The thrust referred to above may be the maximum net thrust at standard atmospheric conditions at sea level plus 15 deg C. (ambient pressure 101.3 kPa, temperature 30 deg C.), with the engine being static

In use, the temperature of the flow at the entry to the high pressure turbine may be particularly high. This temperature, which may be referred to as TET, may be measured at the exit to the combustion device, for example immediately upstream of the first turbine vane, which itself may be referred to as a nozzle guide vane. At cruise, the TET may be at least (or on the order of): 1400 K, 1450 K, 1500 K, 1550 K, 1600 K or 1650 K. The TET at cruise may be in a closed range bounded by any two of the values in the previous sentence (i.e. the values may represent upper or lower bounds). The maximum TET in use of the engine may be, for example, at least (or on the order of): 1700 K, 1750 K, 1800 K, 1850 K, 1900 K, 1950 K or 2000 K. The maximum TET may be in a closed range bounded by any two of the values in the previous sentence (i.e. the values may represent upper or lower bounds). The maximum TET may occur, for example, at a high thrust condition, for example at a maximum take-off (MTO) condition.

A fan blade and/or aerofoil portion of a fan blade as described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fiber. By way of further example at least a part of the fan blade and/or aerofoil may be manufactured at least in part from a metal, such as a titanium based metal or an aluminum based material (such as an aluminum-lithium alloy) or a steel based material. The fan blade may comprise at least two regions that are manufactured by using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fiber or aluminum based body (such as an aluminum lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be present in the form of a dovetail that may be inserted into a corresponding slot in the hub/disc and/or may engage with the same in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow for the exit area of the bypass duct to be varied during operation. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may refer to the cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of descend.

Purely by way of example, the forward speed at the cruise condition may be any point in the range from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85, or in the range from 0.8 to 0.85. Any single speed within these ranges may be the cruise condition. For some aircrafts, the cruise conditions may be outside these ranges, for example below Mach 0.7 or above Mach 0.9.

Purely by way of example, the cruise conditions may correspond to standard atmospheric conditions at an altitude that is in the range from 10000 m to 15000 m, for example in the range from 10000 m to 12000 m, for example in the range from 10400 m to 11600 m (around 38000 ft), for example in the range from 10500 m to 11500 m, for example in the range from 10600 m to 11400 m, for example in the range from 10700 m (around 35000 ft) to 11300 m, for example in the range from 10800 m to 11200 m, for example in the range from 10900 m to 11100 m, for example on the order of 11000 m. The cruise conditions may correspond to standard atmospheric conditions at any given altitude in these ranges.

Purely by way of example, the cruise conditions may correspond to the following: a forward Mach number of 0.8; a pressure of 23000 Pa; and a temperature of −55 deg C.

As used anywhere herein, “cruise” or “cruise conditions” may refer to the aerodynamic design point. Such an aerodynamic design point (or ADP) may correspond to the conditions (comprising, for example, one or more of the Mach Number, environmental conditions and thrust requirement) in which the fan is designed to operate. This may mean, for example, the conditions at which the fan (or the gas turbine engine) is designed to have optimum efficiency.

During operation, a gas turbine engine as described and/or claimed herein may operate at the cruise conditions defined elsewhere herein. Such cruise conditions may be determined by the cruise conditions (for example the mid-cruise conditions) of an aircraft to which at least one (for example two or four) of the gas turbine(s) engine may be mounted in order to provide propulsive thrust.

The skilled person will appreciate that, except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

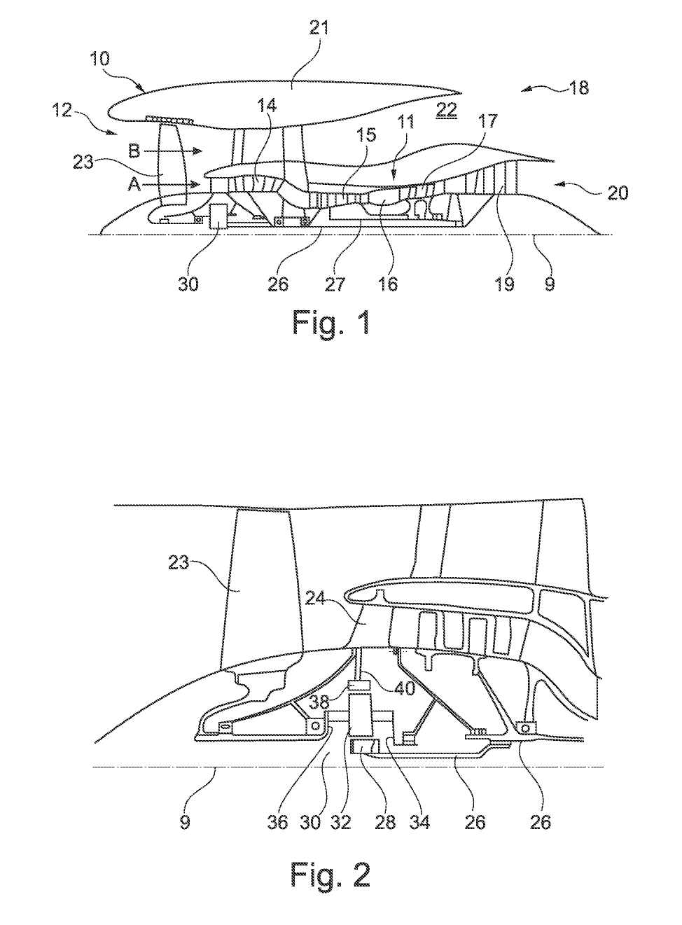

FIG. 1 shows a lateral sectional view of a gear fan engine;

FIG. 2 shows a large sectional view of an upstream section of a gas turbine engine;

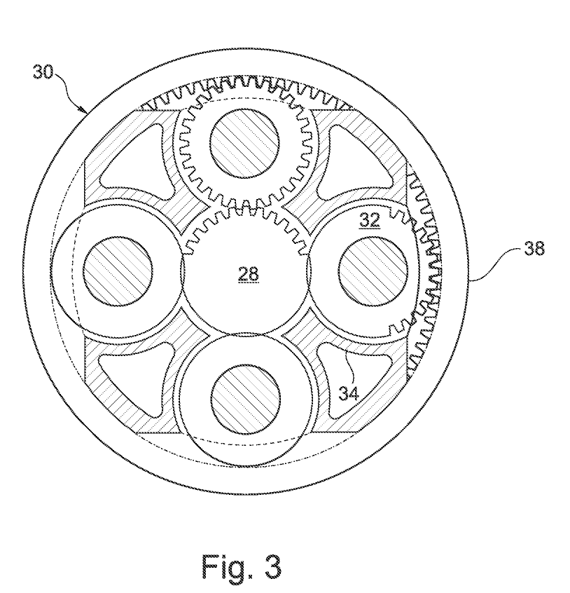

FIG. 3 shows a partial cut-away view of a gearbox for a gas turbine engine;

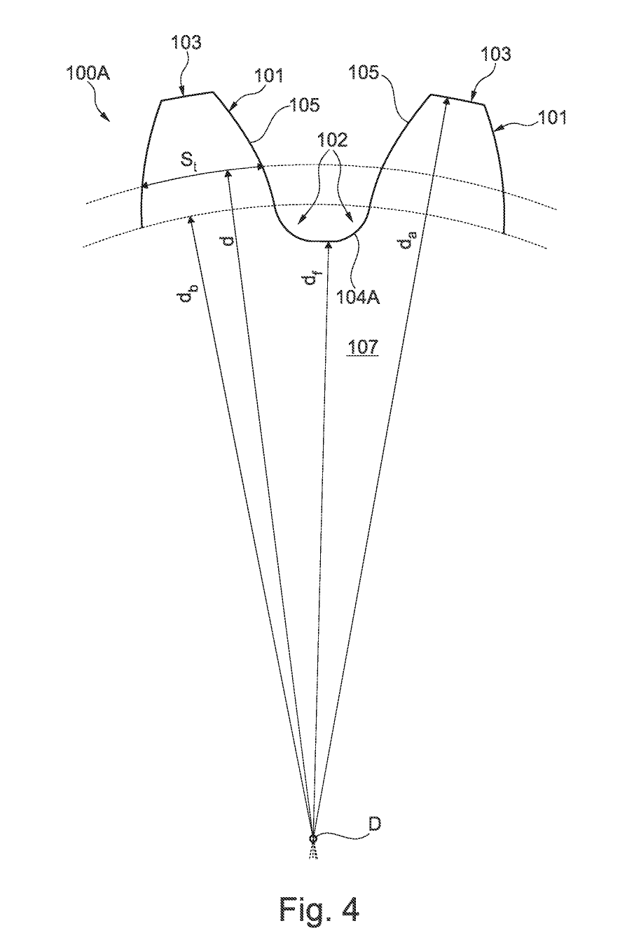

FIG. 4 shows a section of a symmetrical toothing in the transverse section, wherein two teeth are shown which are connected to each other via a symmetrical tooth root shape;

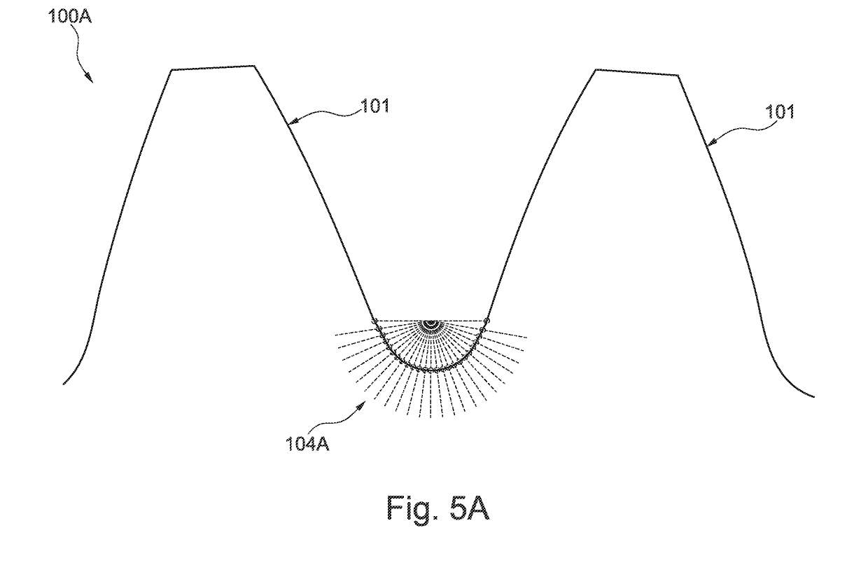

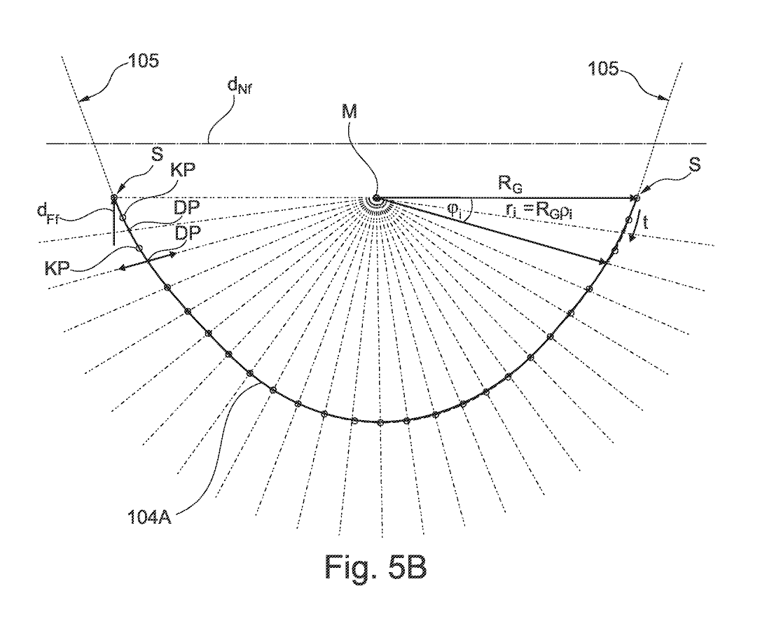

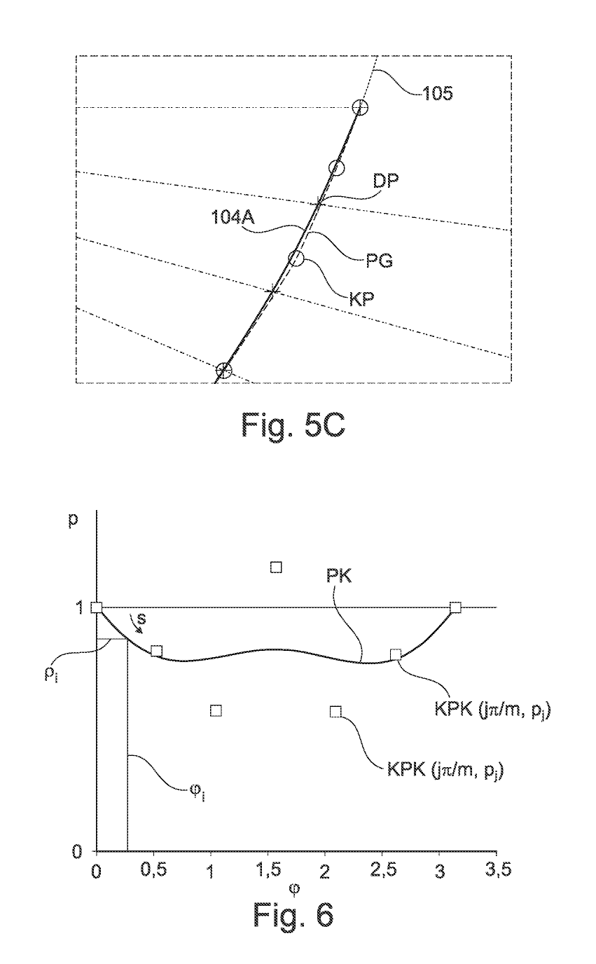

FIG. 5A shows an enlarged section of the toothing according to FIG. 4, wherein a B-spline curve is indicated;

FIG. 5B shows a further enlarged section of the toothing according to FIG. 5A;

FIG. 5C shows a further enlarged section of the toothing according to FIG. 5A;

FIG. 6 shows a perturbation curve for determining the defining points of the B-spline curve according to FIGS. 5A to 5C;

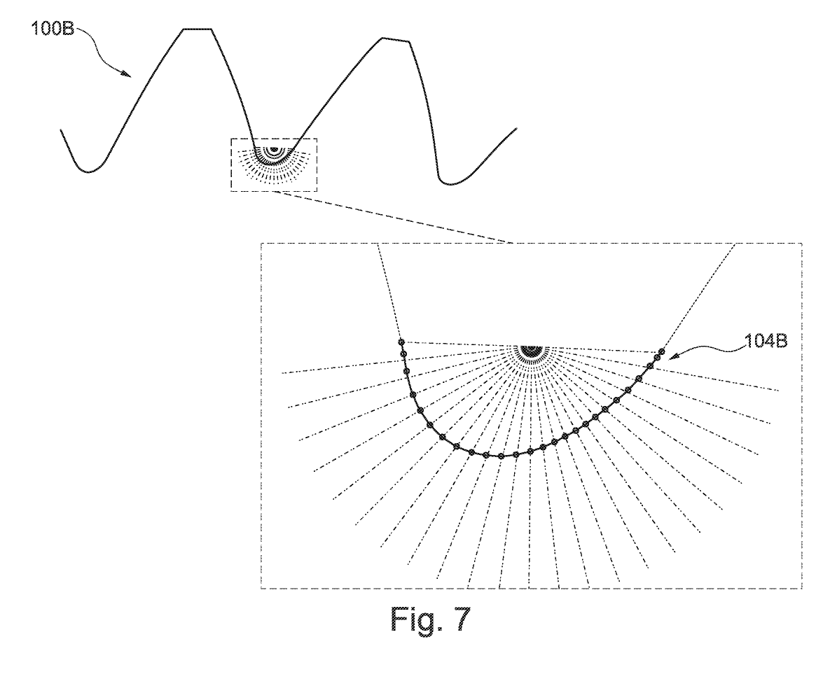

FIG. 7 shows a section of an asymmetrical toothing with an asymmetrical tooth root shape in the transverse section;

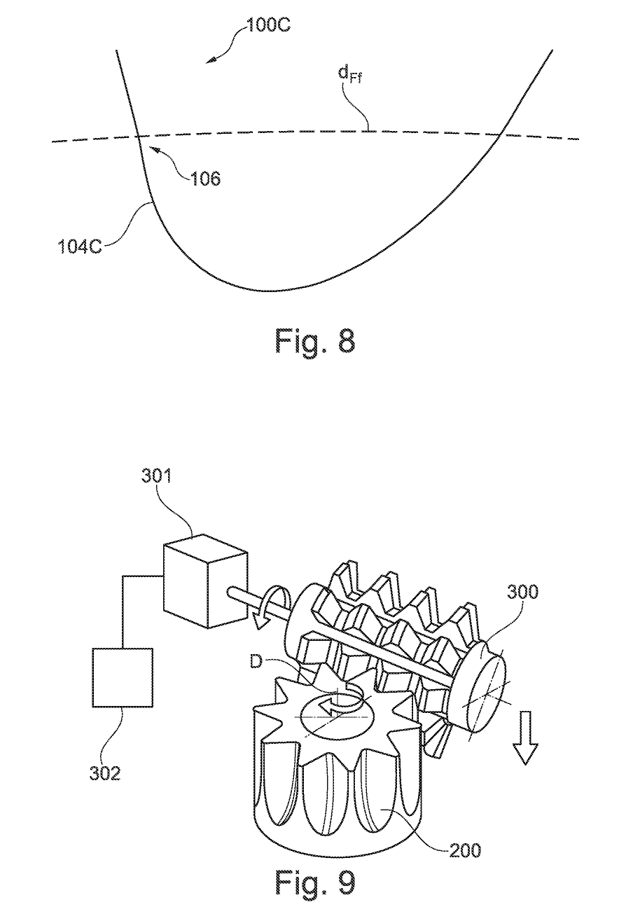

FIG. 8 shows a section of a toothing with a tooth root shape that undercuts a flank of a tooth;

FIG. 9 shows a tool for forming a toothing at a work piece;

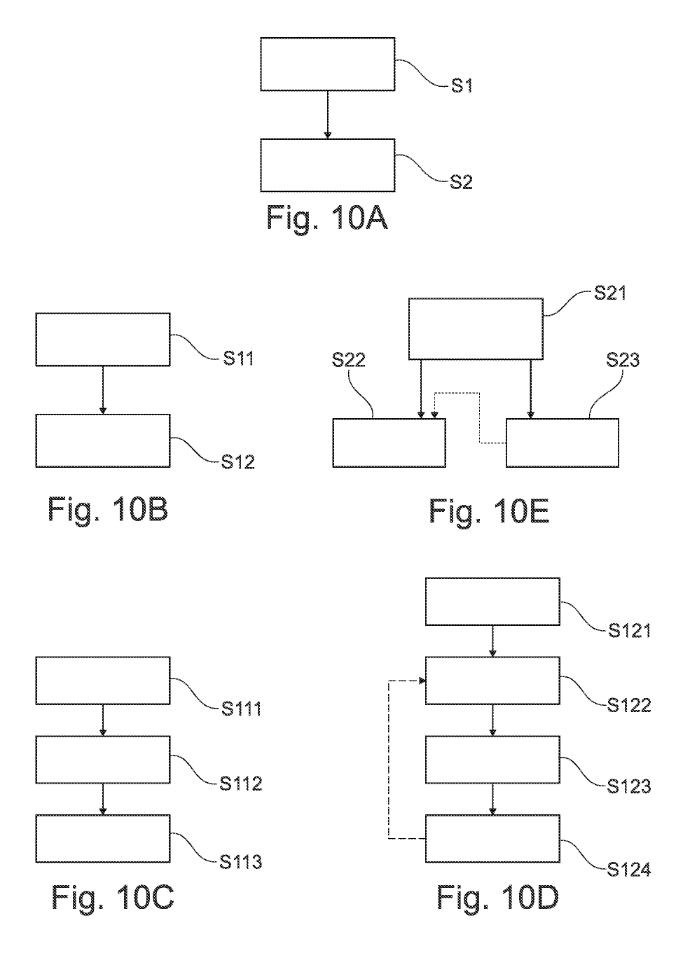

FIGS. 10A to 10E shows a method for producing a toothing; and

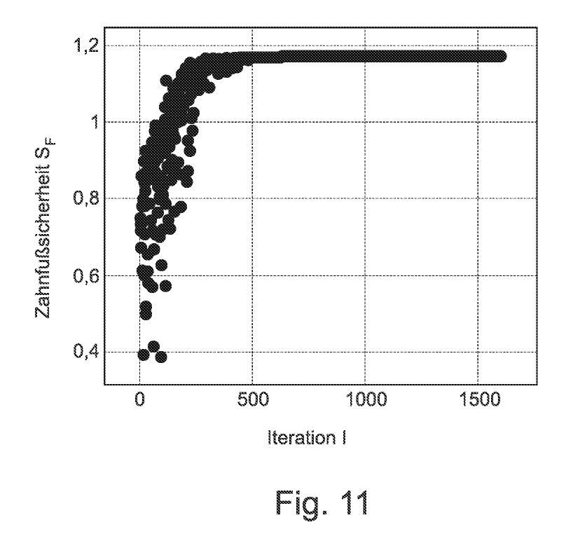

FIG. 11 shows determined values for a tooth root safety after a certain number of iterations.

FIG. 1 shows a gas turbine engine 10 with a main rotational axis 9. The engine 10 comprises an air intake 12 and a fan 23 that generates two airflows: a core airflow A and a bypass airflow B. The gas turbine engine 10 comprises a core 11 that receives the core air flow A. The core engine 11 comprises, with respect to the axial flow order, a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass channel 22 and a bypass thrust nozzle 18. The bypass air flow B flows through the bypass channel 22. Via a shaft 26 and an epicyclic planetary gearbox 30, the fan 23 is attached to a low-pressure turbine 19, and is driven by the same.

During operation, the core airflow A is accelerated and compressed by the low-pressure compressor 14, where further compression takes place. The air that is discharged from the high-pressure compressor 15 in a compressed state is directed into the combustion device 16 where it is mixed with fuel and the mixture is combusted. The resulting hot combustion products are then propagated through the high-pressure turbine 17 and the low-pressure turbine 19 and thus drive it by before being discharged through the core exhaust nozzle 20 for providing a certain thrust. The high-pressure turbine 17 drives the high-pressure compressor 15 via a suitable interconnecting shaft 27. The fan 23 usually provides the greatest portion of the propulsive thrust. The epicyclic planetary gearbox 30 is a reduction gear.

An exemplary arrangement for a geared fan gas turbine engine 10 is shown in FIG. 2. The low pressure turbine 19 (see FIG. 1) drives the shaft 26, which is coupled to a sun gear 28 of the epicyclic planetary gearbox 30. Located radially outwardly of the sun gear 28 and intermeshing therewith is a plurality of planetary gears 32 that are coupled with each other by a planet carrier 34. The planet carrier 34 forces the planetary gears 32 to precess around the sun gear 28 in synchronicity whilst enabling each planet gear 32 to rotate about its own axis. Via linkages 36, the planet carrier 34 is coupled to the fan 23 in order to cause its rotation about the rotational axis 9. An annulus or ring gear 38 that is coupled via the linkage 40 to a stationary support structure 24, is located radially outside of the planetary gears 32 and intermeshes therewith.

Note that the terms “low pressure turbine” and “low pressure compressor” as used herein may be taken to refer to the turbine stages with the lowest pressure and the compressor stages with the lowest pressure (i.e., not including the fan 23) and/or refer to the turbine and compressor stages that are connected to each other by the interconnecting shaft 26 with the lowest rotational speed in the engine (i.e., not including the gearbox output shaft that drives the fan 23). In some documents, the “low pressure turbine” and the “low pressure compressor” referred to herein may alternatively also be known as an “intermediate pressure turbine” and an “intermediate pressure compressor”. Where such alternative nomenclature is used, the fan 23 may be referred to as a first or lowest pressure stage.

The epicyclic planetary gearbox 30 is shown in more detail in FIG. 3 by way of example. The sun gear 28, the planetary wheels 32 and the ring gear 38 respectively comprise teeth at their circumference to facilitate meshing with other gears. However, with a view to clarity, only exemplary sections of the teeth are shown in FIG. 3. Although four planetary wheels 32 are shown, it will be clear to a person skilled in the art that more or less planetary wheels 32 can be provided within the scope of the claimed invention. Practical applications of the epicyclic planetary gearbox 30 generally comprise at least three planetary wheels 32.

The epicyclic planetary gearbox 30 shown in FIGS. 2 and 3 by way of example is a planetary gearbox, in which the planetary carrier 34 is coupled via linkages 36 to an output shaft, wherein the ring gear 38 is fixedly attached. However, it is also possible to use any other suitable type of a planetary gearbox 30. By way of further example, the planetary gearbox 30 may comprise a star arrangement, in which the planet carrier 34 is supported in a fixed manner, and the ring (or annulus) gear 38 is rotatable. In such an arrangement, the fan 23 is driven by the ring gear 38. By way of further alternative example, the gearbox 30 may be a differential gearbox in which the ring gear 38 as well as the planet carrier 34 are rotatable.

It will be obvious that the arrangement shown in FIGS. 2 and 3 serves merely as an example, and the scope of the present disclosure also comprises various alternatives. Purely by way of example, any suitable arrangement may be used for arranging the gearbox 30 in the gas turbine engine 10 and/or for connecting the gearbox 30 to the gas turbine engine 10. By way of further example, the connections (such as the linkages 36, 40 in the example of FIG. 2) between the gearbox 30 and other parts of the gas turbine engine 10 (such as the input shaft 26, the output shaft and the stationary support structure 24) may have a certain degree of stiffness or flexibility. By way of further example, any suitable arrangement of the bearings between rotating and stationary parts of the gas turbine engine 10 (for example between the input and output shafts of the gearbox 30 and the fixed structures, such as for example the gearbox casing) may be used, and the disclosure is not limited to the exemplary arrangement of FIG. 2. For example, where the gearbox 30 has a star arrangement (as described above), the person skilled in the art would readily understand that the arrangement of output and support connections and bearing locations would typically be different from that shown in FIG. 2.

Accordingly, the present disclosure extends to a gas turbine engine 10 having any arrangement of gearbox styles (for example star arrangement or epicyclic planetary arrangements), support structures, input and output shaft arrangement, and bearing locations.

Optionally, the gearbox may drive additional and/or alternative components (e.g. the intermediate pressure compressor and/or a booster compressor).

Other gas turbine engines 10 to which the present disclosure may be applied may have alternative configurations. For example, such engines may have a different number of compressors and/or turbines and/or a different number of interconnecting shafts. By way of further example, the gas turbine engine shown in FIG. 1 has a split flow nozzle 20, 22, meaning that the flow through the bypass channel 22 has its own nozzle that is separate from and arranged radially outside of the core engine exhaust nozzle 20. However, this is not to be taken in a limiting manner, and any aspect of the present disclosure may also apply to engines in which the flow through the bypass channel 22 and the flow through the core engine 11 is intermixed or combined in front (or upstream) of a single nozzle, which may be referred to as a mixed flow nozzle. One or both nozzles may have a fixed or variable cross section (independently of whether a mixed or a partial flow is present). Whilst the example described herein relates to a turbofan engine, the disclosure may apply, for example, to any type of turbine engine, such for example in an open rotor (in which the fan stage is not surrounded by an engine nacelle) or to a turboprop engine, for example.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the view in the FIG. 1 view). The axial, radial and circumferential directions are mutually perpendicular.

FIG. 4 shows a part of a gear element, concretely of a gear wheel, in the transverse section. The gear wheel may e.g. be one of the planetary wheels 32 or the sun gear 28 according to FIG. 3. The gear wheel comprises a toothing 100A with multiple teeth 101, of which two are shown in FIG. 4.

Each of the teeth 101 has a tooth tip 103 that is facing away from the rotational axis D of the gear wheel, and a tooth root 102 via which the tooth 101 is connected to a base body 107 of the gear wheel. The base body 107 is a circular cylinder or alternatively a hollow circular cylinder. The teeth 101 are arranged at an outer circumference of the base body 107. In other toothings, e.g. the toothing of a ring gear, for example of the ring gear 38 according to FIG. 3, the base body 107 can be a hollow circular cylinder, wherein the teeth are arranged at the inner circumference of the hollow circular cylinder.

At its flanks, each of the teeth 101 has an involute profile 105. If a taut thread is unwound form the circumference of a circle, the course of the thread end describes an involute. With spur gears, the circle for defining the involute is referred to as the base circle. In FIG. 4, the base circle diameter d_{b} is indicated. Further, the pitch circle diameter d is indicated in FIG. 4. The pitch circle diameter d is calculated based on the number of teeth and the module of the toothing. Further, FIG. 4 shows the tip diameter dₐ and the tooth root diameter d_{f}, the difference of which indicates the tooth height of the teeth 101. The tip diameter dₐ delimits the toothing 100A radially outwards, the tooth root diameter d_{f} delimits the toothing 100A radially inwards. The tip diameter dₐ e.g. corresponds to the diameter of the gear wheel with the toothing 100A. A spur gear thickness sₜ indicates the length of the partial circular arc between the two flanks of the tooth 101.

Respectively two adjacent teeth 101 describe a tooth root shape 104A together. The tooth root shape 104A is a concave surface and a concave line in the transverse section according to FIG. 4. The tooth root shape 104A comprises at least one point of the surface of the toothing 100A between two teeth 101 that is arranged at the root circle with the tooth root diameter d_{f}.

FIGS. 5A to 5C respectively show further enlarged sections of the toothing 100A according to FIG. 4 in the transverse section.

In FIG. 5B, two further diameters referring to the rotational axis D of the toothing 100A are indicated, a root use diameter d_{Nf} and a root form diameter d_{Ff}, which will now be initially described. In contrast to the tip diameter dₐ, the tooth root diameter d_{f} does not delimit the active part of the tooth flank. The active part of the tooth flank comes into contact with a counter toothing that meshes with the toothing 100 when the toothing 100A and the counter toothing roll off against each other. Viewed in the direction from the tooth root 102 to the tooth tip 103, the active part of the flank starts at the root use diameter d_{Nf} (which is also referred to as the “start of active profile”, SAP). The root use diameter d_{Nf} is determined by the tip diameter of the counter toothing. In FIG. 5B, the position of the root use diameter d_{Nf} of a gearbox with the toothing 100A and the counter toothing is drawn in by way of example. The gearbox is embodied in such a manner that the root use diameter d_{Nf} is larger than a root form diameter d_{Ff} of the toothing 100A. In the shown example, the root form diameter d_{Ff} is that diameter at which the transition from the tooth root shape 104A to the involute profile 105 occurs. In this manner, it can be ensured that only the involute profile 105 is touched by the counter toothing. A nominal distance is provided between the root use diameter d_{Nf} and the root form diameter d_{Ff}.

The tooth root shape 104A is embodied according to a spline curve, in general at least in certain sections, in the shown example completely. In the shown example, the tooth root shape 104A is formed according to a B-spline curve. Put differently: the tooth root shape 104A is a B-spline curve. In the present case, the B-spline curve has the third degree, but alternatively also a degree 2 or higher degrees than 3 are possible.

The B-spline functions N_{k,g} (which are normed and belong to the knot vector) form a base of a spline space. They are locally defined and linearly independent. The B-spline functions have local supports. The B-spline functions form a positive partition of unity. Beginning and end of the B-spline curve are defined by points of intersection S of the flanks of the teeth 101 with the root form diameter d_{Ff} (or the root form diameters d_{Ff} of the two teeth 101, if these are different).

The interpolation conditions of the B-spline curve are defined as follows (in the transverse section of the toothing):

$$[ \begin{matrix}x ( {t}_{i} ) \\ y ( {t}_{i} )\end{matrix} ] = {\sum }_{k = 0}^{n} {N}_{k , g} ( {t}_{i} ) [ \begin{matrix}{x}_{k} \\ {y}_{k}\end{matrix} ] {=}^{!} [ \begin{matrix}{x}_{i} \\ {y}_{i}\end{matrix} ]$$

Here,

$$[ \begin{matrix}{x}_{i} \\ {y}_{i}\end{matrix} ]$$

represent the (n+1) defining points DP of the B-spline curve. Further,

$$[ \begin{matrix}{x}_{k} \\ {y}_{k}\end{matrix} ]$$

represent the (n+1) control points KP of the B-spline curve. The variables tᵢ run along the B-spline curve. As the origin of coordinates for the Cartesian coordinates xy that point can e.g. be chosen at which the transverse section intersects with the rotational axis D, the center point M or one of the two points of intersection S.

In FIGS. 5A to 5C, circles are used to illustrate the control points KP of the B-spline curve that describes the tooth root shape 104A. Crosses illustrate the defining points DP of the B-spline curve. The B-spline curve is of an interpolating type and passes through the defining points DP. The B-spline curve (the tooth root shape 104A) is located within the convex hull of the control points KP. The control polygon PG of the control points KP is indicated by a dashed line (see in particular FIGS. 5B and 5C). The control points KP are determined based on the degree of the B-spline curve and the defining points DP

The parameterization of the B-spline curve is realized by means of auxiliary variables. A straight line (line segment) is placed between the two points of intersection S of the flanks of the teeth 101 with the root form diameter d_{Ff} (or the root form diameters d_{Ff}). The two points of intersection S are thus located on flanks of two of adjacent teeth 101 that do not have a common denominator. One of the points of intersection S can be located on a front flank, while the other of the two points of intersection S is located on the rear flank (with respect to a rotational direction). The center of the straight line between the points of intersection S is indicated as a center point M in FIG. 5B. The distance of the center point M to one of the two points of intersection S (that is, half the length of the line segment) is defined as the basic radius R_{G} of the tooth root shape 104A.

In the shown example, the B-spline curve comprises 25 defining points DP (that can also be referred to as support points). Generally, also less or more defining points DP can be used. For example, the B-spline curve can generally have more than 5, more than 10, more than 20, or more than 24 defining points DP.

Two of the defining points DP are arranged at the two points of intersection S. The other defining points DP are arranged on that side of the straight line between the points of intersection S that faces towards the tooth roots 102 (in other words, the tooth root shape 104A) of the two teeth 101. The defining points DP are arranged along rays that have their origin in the center point M. Here, the rays are distributed evenly about the center point M. Starting from a first defining point DP at one of the points of intersection S, the other defining points DP are arranged at unvarying angular distances up to an angle of 180 degrees, with the defining points DP also having equidistant angles φᵢ about the center point M (below the straight line between the two points of intersection S).

The distance rᵢ of the individual defining points DP from the center point M is defined based on a factor ρᵢ, the factor ρᵢ is multiplied by the basic radius R_{G}, rᵢ=R_{G}ρᵢ. If all factors ρᵢ are set to 1, the defining points DP describe a semicircle. The first and the last defining point DP (at the points of intersection S) are not variable with respect to their position relative to the center point M. In this manner, a G⁰-continuity of the contour of the toothing 100A can be ensured. Here, G⁰-continuity means that the involute profiles 105 and the tooth root shape 104A touch at the transition.

The factors ρᵢ are controlled based on a perturbation curve PK, see FIG. 6. In the present example, the perturbation curve PK is a B-spline curve. In the shown example, the perturbation curve is defined as follows:

$$[ \begin{matrix}ϕ ( s ) \\ ρ ( s )\end{matrix} ] = {\sum }_{j = 0}^{m} {N}_{j , g} ( s ) [ \begin{matrix}j π / m \\ {p}_{j}\end{matrix} ]$$

By means of the perturbation curve PK, the values of the factors ρᵢ can be determined for the predetermined angles φᵢ. The factors ρᵢ are thus selected trough the perturbation curve PK. The perturbation curve PK has a number of (m+1) control points KPK, in the shown example 7 control points KPK, with also less or more control points KPK being conceivable, e.g. 5 to 10 control points KPK, or more than 4, or more than 5 control points. In the present case, the control points KPK are arranged at positions φ=jπ/m (along the axis of abscissas). The first and the last control point KPK are located at the positions φ=0 and φ=π and have a fixed ordinate value of 1 (so that the first and the last control point KP of the tooth root shape 104A are located at the respective point of intersection S). The ordinate values pⱼ of the other control points KPK are variable. These are only 5 values based on which the shape of the perturbation curve PK is set, which in turn determines the shape of the B-spline curve of the tooth root shape 104A. The variable s runs along the perturbation curve PK (B-spline curve).

In this manner, the tooth root shape can be predetermined in a simple and efficient manner with just a few parameters.

The toothing 100A according to FIGS. 4 to 5C is symmetrical. The tooth root shape 104A is also symmetrical. If such a symmetry is to be forced, the factors ρᵢ of a half of the defining points DP can be set to be equal to the values of the factors ρᵢ of the other half of the defining points DP.

As illustrated in FIG. 7, an asymmetrical toothing 100B can also have a tooth root shape 104B that is formed according to a B-spline curve. The tooth root shape 104B according to FIG. 7 is asymmetrical.

Alternatively, it is also possible to form an asymmetrical toothing with a symmetrical tooth root shape. Further, it is possible to form a symmetrical toothing with an asymmetrical tooth root shape.

The tooth root shapes 104A, 104B according to FIGS. 4 to 7 tangentially abut adjacent areas (here the involute profiles 105) of the flanks of the teeth 101. What is thus present is a tangential transition at the root form diameter d_{Ff}. Alternatively, it is possible to provide a non-tangential transition at the root form diameters d_{Ff}. FIG. 8 shows a (in this case asymmetrical, alternatively symmetrical) tooth root shape 104C of a toothing 100C which has an undercut at a point of intersection of the two facing tooth flanks with the root form diameter d_{Ff}. The tooth root shape 104C thus undercuts the tooth flank (in particular the involute profile).

Further, it is to be understood that the root form diameter d_{Ff} of the two adjacent teeth 101 of the respective toothing 100A-100C can be equal or alternatively also different.

The toothings 100A-100C can be formed as spur or helical toothings.

Further, it is alternatively possible to form the B-spline curve of the tooth root shape 104A-104C as a non-interpolating curve, in particular also in such a manner that it is not defined by the defining points DP. In that case, the B-spline curve can optionally be determined by the control points KP. Here, this control points KP can be defined by a perturbation curve (e.g. in a corresponding manner to the one described above), in particular in the form of a B-spline curve.

In the following, a method for producing a toothing, in particular any of the previously described toothings 100A-100C, is described based on FIGS. 9 and 10A to 10E.

In general, FIG. 10A shows two steps of the method. In a first step S1, a tooth root shape 104A-104C is predetermined, defining a shape of the toothing 100A-100C in the area of tooth roots 102 of adjacent teeth 101. Here, the tooth root shape 104 is described by a spline curve (in particular by a B-spline curve) at least in certain sections, in particular completely.

In a second step S2, the toothing 100A-100C with the tooth root shape 104A-104C is formed, e.g. by a work piece being provided with a toothing 100A-100C.

FIG. 10B shows possible steps S11, S12 that the step S1 of predefining the tooth root shape 104A-104C according to FIG. 1 can additionally comprise. A step S11 comprises defining parameters of a parameter set (e.g. the totality of the defining points DP of the B-spline curve). Defining the parameters can mean defining the parameters in polar coordinates, e.g. analogously to FIG. 5B. A further step S12 comprises optimizing the parameters of this parameter set.

FIG. 10C shows possible steps S111-S113 that the step S11 of defining the parameters of a parameter set can additionally comprise. A step S111 comprises constructing a center point M of a connecting line between facing flanks of adjacent teeth 101 at the height of a root form diameter d_{Ff} of the toothing 100A-100C. A further step S112 comprises dividing the semicircle that is facing the tooth root shape 104A-104C about the center point M in multiple equidistant angles φᵢ. A further step S113 comprises defining the parameters through respectively one of the angles φᵢ and/or a radial distance rᵢ to the center point M. Here, the angles φᵢ can be maintained and the rᵢ can be variable. Optionally, the angles φᵢ and distances rᵢ can be converted into Cartesian coordinates, which may then serve as variable parameters.

FIG. 10D shows possible steps S121-S124 that the step S12 of optimizing the parameters can additionally comprise. A step S121 comprises defining a perturbation curve PK described by a parameter set (e.g. the control points of the perturbation curve KPK), wherein (the variable) parameters of the parameter set of the (B) spline curve (of the tooth root shape 104A-104C) are determined by the perturbation curve PK. As already described, the perturbation curve PK may e.g. also be a spline curve, in particular a B-spline curve. Here, the number of parameters of the perturbation curve PK can be smaller than the number of parameters of the (B) spline curve of the tooth root shape 104A-104C (e.g. no more than half to a fifth of the same).

A further step S122 comprises predefining multiple parameter sets with varied parameter values. In the course of it, it is optionally possible to predetermine start values (e.g. all values pᵢ are set to 1). Variation may e.g. be performed in discrete steps and/or based on random numbers or pseudo random numbers. The variation is in particular performed within a definition range. The definition range may e.g. be 0≤pᵢ≤2 (0 smaller or equal to pᵢ smaller or equal to 2; in particular if the perturbation curve PK is a B-spline curve, as in the above example, the perturbation curve PK is located inside the convex hull of its control polygon).

A further step S123 comprises establishing, for each of the multiple parameter sets, a tooth root load-carrying capacity of a toothing 100A-100C with a tooth root shape 104A-104C that is described by a (B) spline curve according to the respective parameter set. This may e.g. be performed by means of a FEM model, in particular in the normal cut. The calculation of the tooth root load-carrying capacity can also be performed with other numerical methods (e.g. the boundary element method, BEM). The calculation does not necessarily have to take place only in the normal cut. Also, a 3D-calculation and/or optimizing is possible. For example, a variable tooth root surface in the axial direction is possible, which e.g. can be determined by a three-dimensional calculation and/or optimizing. A tooth root safety S_{F}, e.g. can be calculated according to the international norm ISO 6336-3 and/or according to guideline VDI 2737. The tooth root load-carrying capacity can be determined based on the tooth root safety.

A further step S124 comprises determining that parameter set of the (B) spline curve for which the highest tooth root load-carrying capacity has been determined. The steps S122 to S124 can optionally be performed in multiple iterations. Here, a maximum number for the repetitions and/or a stop criterion (e.g. converging parameter) can be predetermined. In particular, the values pⱼ of the perturbation curve PK can be subjected to the optimization process. Based on the perturbation curve PK, the modified values pⱼ yield the defining points DP of the B-spline curve of the tooth root shape 104A-104C, whereby the B-spline curve can be uniquely defined.

FIG. 11 shows how tooth root curves with considerably improving tooth root securities can be determined in an example with more than 1500 iterations. As can be seen, the parameters converge around approximately 500 iterations. The starting point was a commercially available planetary gearbox with a sun gear, four planets, and one ring gear. Here, any desired gearbox pairing can be regarded. By means of the described method, improvements of the tooth root reliability by approximately 17% can be achieved as compared to the initial gearbox, which serves only as an example. The described toothing 100A-100C can be used with different gear elements, in particular in gear elements of a gearbox of a gas turbine engine.

The steps S121 to S124 can e.g. be performed in an automated manner, in particular by means of a computer 302 (see in particular FIG. 9). The computer 302 (or another computer, or another control device that has received a representation of the tooth root curve 104A-104C) can select a drive 301 in such a manner that a toothing 100A-100C with the optimized tooth root shape 104A-104C (with the optimized parameter set) is formed by means of a tool 300 at a work piece 200.

The tool 300 according to FIG. 9 is a hob cutter, so that forming the toothing can comprise gear hobbing. In general, FIG. 10E shows possible steps S21-S23 that the step S2 of forming the toothing 100A-100C with the tooth root shape 104A-104C can additionally comprise. In a step S2, a work piece 200 is provided. A further step S22 comprises cutting machining of the work piece 200, e.g. forming cutting or shape grinding, in particular the already mentioned gear hobbing, for forming a gear element. An alternative step S23 comprises primary forming a work piece or a gear element with the toothing 100A-100C. Optionally, the step S22 is performed after primary forming.

The produced gear element with the toothing 100A-100C is in particular a gear element according to FIG. 3.

It is to be understood that the invention is not limited to the above described embodiments and various modifications and improvements can be realized without departing from the concepts described herein. Except where they are mutually exclusive, any of the features can be used separately or in combination with any other features, and the disclosure extends to all combinations and sub-combinations of one or multiple features described herein and includes the same.

### PARTS LIST

9 main rotational axis
10 gas turbine engine
11 core engine
12 air intake
14 low-pressure compressor
15 high-pressure compressor
16 combustion device
17 high-pressure turbine
18 bypass thrust nozzle
19 low-pressure turbine
20 core thrust nozzle
21 engine nacelle
22 bypass channel
23 fan
24 stationary support structure
26 shaft
27 connecting shaft
28 sun gear
30 gearbox
32 planetary wheels
34 planetary carrier
36 linkage
38 ring gear
40 linkage
100A-100C toothing
101 tooth
102 tooth root
103 tooth tip
104A-104C tooth root shape
105 involute profile
106 undercut
107 base body
200 work piece
300 tool
301 drive
302 computer
A core air flow
B bypass air flow
D rotational axis
DP defining point
KP control point
M center point
PG control polygon
PK perturbation curve
KPK control point (perturbation curve)
S point of intersection
d pitch circle diameter
dₐ tip diameter
d_{b} base circle diameter
d_{f} tooth root diameter
d_{Ff} root form diameter
d_{Nf} root use diameter
pᵢ parameter (perturbation curve)
R_{G} basic radius
Rᵢ radius
sₜ spur gear thickness
φᵢ angles
ρᵢ factor

1.-16. (canceled)

17. A method for producing a toothing with multiple teeth of a gear element for a gas turbine engine, comprising the following steps:
predefining a tooth root shape that defines a shape of the toothing in the area of tooth roots of adjacent teeth, wherein the tooth root shape is described by a spline curve at least in certain sections, in particular completely; and
forming the toothing with the tooth root shape.

18. The method according to claim 17, wherein the spline curve is a B-spline curve.

19. The method according to claim 17, wherein the spline curve comprises multiple polynomials that are composed piecewise.

20. The method according to claim 17, wherein the toothing is a spur gear toothing.

21. The method according to claim 17, wherein the spline curve has a parameter set with multiple parameters, wherein the parameters of the parameter set of the spline curve are respectively defined in polar coordinates as follows:
constructing a center point of a connecting line between facing flanks of adjacent teeth at the height of a root form diameter (d_{Ff}) of the toothing;
dividing the semicircle that is facing the tooth root shape about the center point in multiple equidistant angles (φᵢ); and
defining of the parameters by respectively one of the angles (φᵢ) and a radial distance (rᵢ) to the center point.

22. The method according to claim 21, wherein the predefining of the tooth root shape comprises optimizing of the parameters.

23. The method according to claim 22, wherein optimizing the parameters comprises defining a perturbation curve described by a parameter set, wherein the parameters of the parameter set of the spline curve are determined by the perturbation curve.

24. The method according to claim 23, wherein the perturbation curve is a spline curve, in particular a B-spline curve.

25. The method according to claim 23, wherein the number of parameters (pⱼ) of the perturbation curve is smaller than the number of parameters of the spline curve of the tooth root shape.

26. The method according to claim 22, wherein optimizing of the parameters comprises the following:
predefining multiple parameter sets with varied values of the parameters;
establishing, for each of the multiple parameter sets, a tooth root load-carrying capacity of a toothing with a tooth root shape, which is described by a spline curve with the respective parameter set; and
determining the parameter set of the spline curve, for which the highest tooth root load-carrying capacity has been determined.

27. The method according to claim 1, wherein the spline curve of the tooth root shape has 5 or more than 5, in particular more than 10, control points.

28. The method according to claim 1, wherein the spline curve of the tooth root shape has an uneven number of control points.

29. The method according to claim 1, wherein the spline curve of the tooth root shape is an interpolating spline curve.

30. The method according to claim 1, wherein the spline curve of the tooth root shape is a non-interpolating spline curve and is determined by control points.

31. The method according to claim 1, wherein forming of the toothing comprises providing a work piece and a cutting machining of the work piece.

32. A toothing for a gear element of a gas turbine engine, in particular produced by a method according claim 1, wherein the toothing comprises multiple teeth and a tooth root shape which is formed in the area of tooth roots of adjacent teeth which is formed according to a spline curve at least in certain sections, in particular completely.

33. The toothing according to claim 32, wherein the toothing is symmetrical or asymmetrical and the tooth root shape is symmetrical or asymmetrical.

34. A gear element for a gear of a gas turbine engine, wherein the gearbox can be driven by a core shaft of the gas turbine engine, so that a fan of the gas turbine engine can be driven by means of the gear with a lower rotational speed than the core shaft, wherein the gear element has a toothing according to claim 32.

35. A gas turbine engine for an aircraft, comprising:
a core engine, comprising a turbine, a compressor and a core engine shaft for connecting the turbine to a compressor,
a fan upstream of the core engine, wherein the fan has multiple fan blades, and
a gearbox that can be driven by the core shaft, wherein the fan can be driven by means of the gearbox with a lower rotational speed than the core shaft, wherein the gearbox comprises a gear element with a toothing according to claim 32.

36. The gas turbine engine according to claim 35, wherein:
the turbine is a first turbine, the compressor is a first compressor and the core shaft is a first core shaft;
the core engine further comprises a second turbine, a second compressor and a second core shaft that connects the second turbine to the second compressor; and
the second turbine, the second compressor and the second core shaft are arranged such that they rotate with a higher rotational speed than the first core shaft.

37. Method according to claim 17, any of the preceding claims, where the spline curve of the tooth root shape is defined individually for different cross sections of the gear leading to an axially variable tooth root surface.
